(19) United States
(12) Patent Application Publication
(10) Pub. No.: US 2007/0007453 A1
(43) Pub. Date: Jan. 11, 2007

(54) Usage log for mechanical and electrical functions of medical imaging systems

(76) Inventors: Ansgar Graw, Chicago, IL (US); Xavier Battle, Oak Park, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/454,321

(22) Filed: Jun. 16, 2006

Related U.S. Application Data
(60) Provisional application No. 60/691,333, filed on Jun. 16, 2005.

(51) Int. Cl. G01T 1/20

(52) U.S. Cl. 250/363.01

(57) ABSTRACT

A method for monitoring mechanical and electrical functions of a medical imaging system is provided. The method includes monitoring at least one configuration of the medical imaging system, storing the at least one configuration in a database, performing a diagnostic on the mechanical and electrical functions of the medical imaging system, storing a result of the diagnostic on the mechanical and electrical functions in the database, and correlating the at least one configuration with the result of the diagnostic.

### PRIORITY CLAIM TO RELATED APPLICATION

This application claims priority from U.S. Provisional Patent Application Ser. No. 60/691,333, filed Jun. 16, 2006, the disclosure of which is incorporated by reference in its entirety herein.

### BACKGROUND

1. Field of the Invention

The present invention relates to the monitoring of components; and more specifically the present invention relates to the monitoring of mechanical and electrical components in a medical imaging system.

2. Background of the Invention

In the design and manufacturing of a product, performance and life expectancy have played a crucial role in what components are selected along with their reliability characteristics. Since most products have an eventual customer that will be using the product, the overall reliability of the product is often based on customer needs, market expectation, or other similar based measures of end user reliability standards. Often, a manufacturer will desire to test the given product so a manufacturing reliability level is set to perform production acceptance testing of the product.

Once a particular goal is set then the individual sub-system and component reliability levels are set to meet the overall design goal. These reliability criteria are designed to allow for the selection of the sub-systems or components based on criteria that will allow the design to perform to specification. However, the actual customer usually does not get the same level of performance as the design criteria suggested. This is caused by various influences during the product life cycle that occur after the selection of sub-systems or components.

The product life cycle downstream of the selection of the sub-systems or components is often affected by additional losses of performance. Some of these losses include skill level used in the manufacturing of the final product and other organizational constraints during manufacturing. Other downstream areas that can be considered are installation, warranty service, customer use (including misuse and/or abuse), and planned or unplanned maintenance. These factors typically play a larger role in the measured and perceived reliability for repairable systems than system design parameters. Such factors, however, are not taken into account when setting overall system reliability goals.

For example, medical imaging equipment can easily exceed the million dollar mark. It is a huge investment for medical clinics and hospitals. Resources such as space and personnel have to be allocated to the equipment in order to see a return on the investment. Any down time for the medical imaging equipment can result in a loss of income for the medical facility as well as dissatisfied patients due to the rescheduling of appointments. Appointments are usually made months in advance in order to receive confirmation from the medical insurance company that the procedure will be covered.

Down time for the medical imaging equipment also results in inefficient use of human resources. For instance, if the medical imaging equipment is down, medical personnel e.g., radiologists cannot work. However, the medical personnel still have to be paid. This puts an additional burden on the medical facility.

Currently, one means used to alleviate the hardship of medical equipment being inoperable is to have a service contract. The problem with a service contract is that the service is reactive. That is, the service personnel are called upon when the medical imaging equipment is inoperable. Therefore, there is still a financial burden on the medical facility due to the down time of the medical imaging equipment.

Another means to alleviate the hardship of medical equipment being inoperable is for the medical facility to rely on the warranty or an extended warranty contract. Warranties, typically, cover the cost of the failed component but not the service.

In addition, warranties as previously discussed are based on the estimated life spans of parts and components. The operating life of a part or component can vary greatly based on usage of the medical imaging equipment. Although the operating life of a component is dynamic, manufacturers treat the operating life of a component as if it is static.

A need exists for anticipating down time for a medical imaging device without placing an undue financial burden on a medical facility.

A need also exists for updating the operating life of a component in real time allowing a medical facility to accurately determine when a component needs to be replaced.

### SUMMARY OF THE INVENTION

Accordingly, the present invention has been made to solve the above-mentioned problems occurring in the prior art, and an object of the present invention is to provide a method for monitoring a medical imaging system.

In accordance with one aspect of the present invention for accomplishing the above object, a method for monitoring mechanical and electrical functions of a medical imaging system is provided. The method includes monitoring at least one configuration of the medical imaging system, storing the at least one configuration in a database, performing a diagnostic on the mechanical and electrical functions of the medical imaging system, storing a result of the diagnostic on the mechanical and electrical functions in the database, and correlating the at least one configuration with the result of the diagnostic.

In accordance with another aspect of the invention a method is provided for retrieving a result of the correlation from the database.

In accordance with still another aspect of the invention a method is provided for retrieving the result of the correlation from the database remotely.

In accordance with a further aspect of the invention a method is provided for retrieving the result of the correlation from the database onsite

In accordance with an aspect of the invention a method is provided for dispatching service personnel based on the correlation.

In accordance with another aspect of the invention a method is provided for updating a product life expectancy based on the correlation.

### BRIEF DESCRIPTION OF THE DRAWINGS

FIG. 1 is a diagram illustrating a medical imaging system in accordance with an embodiment of the present invention;

FIG. 2 is a flowchart illustrating a process for monitoring the components of a medical imaging system in accordance with an embodiment of the present invention; and

FIG. 3 is a block diagram illustrating a processing system in accordance with an embodiment of the present invention.

In the figures, related elements are denoted by similar element numbers.

### DETAILED DESCRIPTION OF EXEMPLARY EMBODIMENTS

In designing a system or other product intended for later use, design criteria including reliability are considered throughout the design process to meet the final customer's or other end user's perceived or actual reliability, which will be referred to as customer reliability. In order to accurately estimate the customer's perceived reliability, organizational and cultural considerations must be considered at the plurality of phases along the product life cycle (PLC). Among others, the product life cycle includes the “box-of-parts,” design, manufacturing, installation mortality, warranty service/customer training, and customer use/planned maintenance.

The box-of-parts phase is the point at which individual components or sub-systems are taken into consideration. These can be conventional off the shelf (COTS) items or specially designed components or sub-systems. This level of reliability is based on characteristics of these individual components and sub-systems. At this point the reliability is based upon the nominal reliability of the components or sub-system.

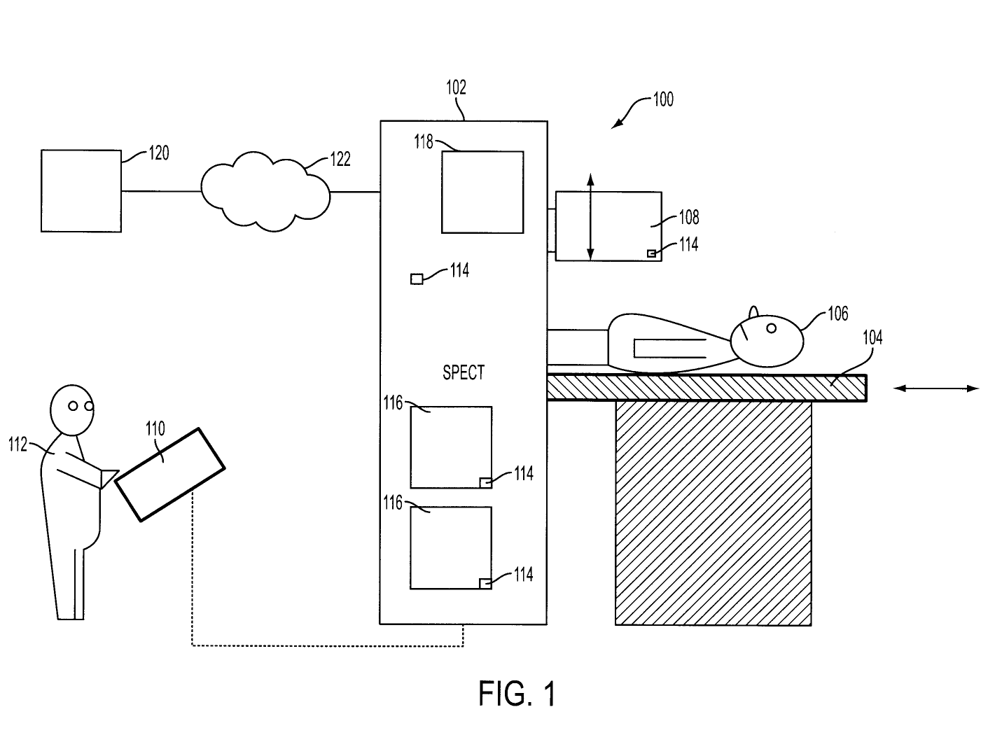

FIG. 1 is a diagram illustrating components of a nuclear medical imaging system 100 (i.e., having a gamma camera or a scintillation camera) which comprises a gantry 102 supporting one or more detectors 108 enclosed within a metal housing and movably supported proximate a patient 106 located on a patient support 104, for example, a pallet. Typically, the positions of the detectors 108 can be changed to a variety of orientations to obtain images of a patient's body from various directions. Detectors 108 can comprise collimators, scintillating elements and/or one or more photodetectors.

Sensors 114 are located throughout the medical imaging system 100. The sensors monitor the mechanical components and the electronic components of the medical imaging system 100. Some of the mechanical components comprise linear drive assemblies, tilt axes, pulleys and the like. The electronic components can comprise system cards 116 and critical and non critical electronic components such as processors and the like.

Usually, a data acquisition console 110 (e.g., with a user interface and/or display) is located proximate a patient during use for a technologist 112 to manipulate during data acquisition. In addition to the data acquisition console 110, images are often developed via a processing computer system which is operated at another image processing computer console including, e.g., an operator interface and a display, which may be located in another room, to develop images. By way of example, the image acquisition data may, in some instances, be transmitted to the processing computer system after acquisition using the acquisition console.

The medical imaging system 100 may comprise at least one of a Positron Emission Tomography (PET) system, a Single Photon Emission Computed Tomography (SPECT) system and a Computed Tomography (CT) system. It should be appreciated by those skilled in the art that other combinations can be used without departing from the scope of the present invention.

Patient positioning is an important step in the acquisition of medical diagnostic scans. It is usually important to cover all of the appropriate anatomy to allow complete diagnosis. However, including non-affected anatomy is not desired for a number of reasons such as but not limited to acquiring and reviewing these portions can waste time, can decrease patient throughput, and for scans using ionizing radiation (such as, e.g., x-ray CT) can add unnecessary doses.

In the context of a hybrid diagnostic imager (e.g., having a combined SPECT and CT system), an even more significant problem exists in relation to correctly positioning a patient because the appropriate anatomy often is not completely apparent in either modality of the hybrid diagnostic imager independently. The detector 108 and patient platform 104 have to be precisely positioned. This adds stress on the mechanical components of the medical imaging system.

As previously discussed, patient positioning is critical due to the potential to expose a patient to excess radiation. For example, if the detector 108 is further away than necessary, a low quality image may be taken. Thus, another image may have to be taken further exposing the patient to additional radiation.

In an embodiment of the present invention, the mechanical components of the medical imaging system are monitored via the sensors 114. The sensors 114 monitor the actual usage of the components including the positioning of the components over time. The different configurations of the medical imaging system 100 are monitored and logged in a database 118.

The database 118 can be located within the medical imaging system 100 or can be located remote from the medical imaging system 100. In an embodiment of the present invention, a periodic diagnostic test is performed on the medical imaging system 100. The sensors 114 provide a status on the mechanical components as well as the system cards 116. When a mechanical component starts to deteriorate or an electronic component begins to provide errors, the information is collected by the database. In an embodiment of the present invention, a service technician is dispatched to prevent any significant down time for the medical imaging system 100. For instance, the service technician can be dispatched in the evenings or during weekends when business for the medical facility is less or nonexistent. In another embodiment of the present invention, the service technician can be dispatched during the day. Since the database 118 would have provided the exact error or faulty component, very little down time will occur.

The information collected from the database 118 can also be used to perform a factory recall. If it is determined that a component is defective throughout the network or a substantial portion of the network, appropriate action can be taken to remedy the situation by changing suppliers and replacing the component.

It should be noted that in accordance with an embodiment of the present invention, service personnel can be dispatched proactively. That is, the service personnel can be dispatched prior to the medical imaging system becoming inoperable. In this embodiment, a diagnostic can determine that the errors detected may lead to a state where the medical imaging system may be down due to issues related to the detected errors.

Information from a plurality of databases is collected from different medical imaging systems. The collected information is sent over network 122. Network 122 may comprise a packet network such as the Internet, or a private network such as a T1/T3 carrier. The collected information is then processed at a processing center where the collected information is used to accurately provide a product life cycle for the mechanical components and the system cards 116 under real world conditions or to dispatch service personnel. In an embodiment of the present invention, the static product life cycle for the mechanical components and the system cards 116 can be updated and users informed converting the static product life cycle into a dynamic life cycle. The users can have the option of having their medical imaging system serviced at fixed intervals. However, the fixed intervals are now based on medical imaging systems that perform under conditions similar to their own medical imaging system. For example, the conditions under which a user's medical imaging system operates can be collected remotely or by a technician onsite or a user onsite. The collected information from the database can be used and compared with other users' systems. This feature can be priced at a lower level than an option where the status of a user's medical imaging system is used to determine servicing. For example, under a higher level pricing plan, if the user's medical imaging system anticipates a failure of the mechanical components or system cards 116, a service technician is dispatched regardless of an expected product life cycle for a mechanical component or system card.

Thus, in one embodiment users can have a lower tier service plan in which their medical equipment is serviced at fixed intervals. However, the fixed intervals are based on information collected from a network of users to create a dynamic fixed interval wherein the fixed interval can be adjusted based on feedback from information collected from other databases. For example, the user may elect to have twelve maintenance visits over a three year period. Rather than performing maintenance over a fixed three month interval, the maintenance visits can be flexible based on the information collected from databases over the network.

In another embodiment, users pay a premium for a proactive network. That is, the database 118 for their own medical imaging system 100 is used to alert service personnel to a potential or actual problem

In still another embodiment of the present invention, the medical imaging system 100 can run a program to run a routine where the medical imaging system 100 goes through a set of prearranged configurations to evaluate the performance of the mechanical and electrical components.

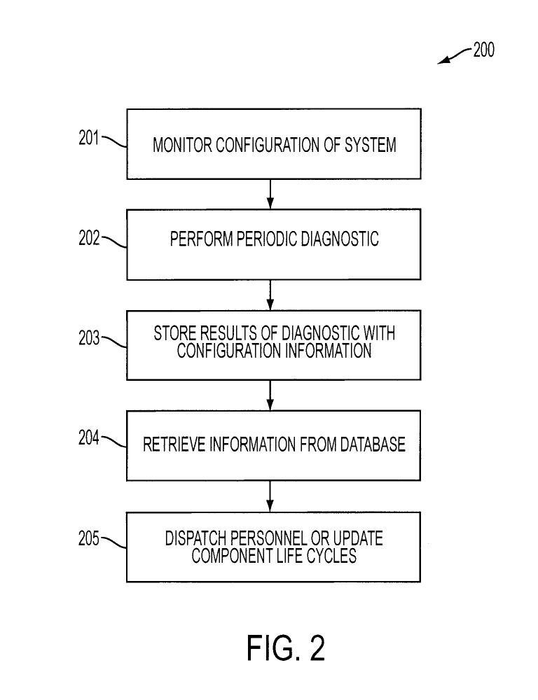

FIG. 2 is a flowchart illustrating a process 200 for monitoring the components of a medical imaging system in accordance with an embodiment of the present invention. The process begins at step 201 where the configuration information of a medical imaging system is stored. All the components both mechanical and electrical used in the configuration are monitored.

At step 202, a periodic diagnostic is performed. The periodic diagnostic can be performed at hourly, daily, weekly, or monthly intervals. This feature can be based on how much a user wants to pay for a service contract, for example. The diagnostic information is retrieved via the sensors 114 connected to the mechanical components and electrical components. Information such as wear and tear on mechanical components and error checking and monitoring for electrical components can be performed.

At step 203, the information from the diagnostic is stored in the database 118 with the configuration information and a correlation is made and stored. The process 200 then proceeds to step 204. At step 204, the information from the database 118 is collected either remotely or onsite. In an onsite environment, a service technician can download the information from database 118 onto a laptop for upload to central station 120. This scenario may be suitable where for security reasons a user does not want remote access to the medical imaging system enabled.

In another embodiment, the user can selectively enable remote access for a designated period of time at set intervals. This restricts access to the medical imaging system for security purposes.

At step 205, the collected information from the databases is analyzed and service personnel is dispatched if the user has paid for that option or the collected information is used to adjust the product life cycles for the various components. Service intervals may be adjusted accordingly.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

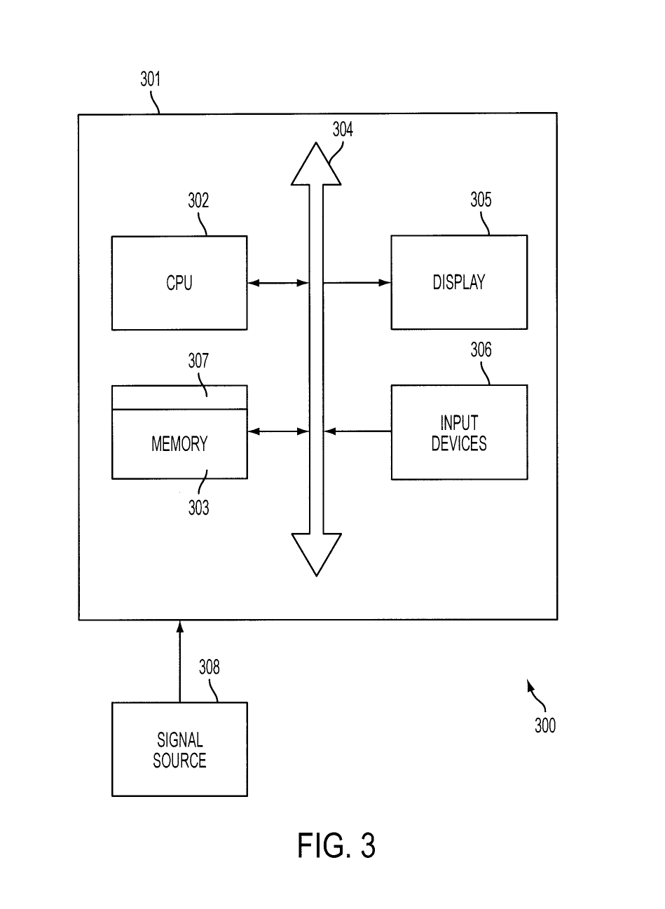

Referring now to FIG. 3, according to an embodiment of the present invention, a computer system 301 for implementing the present invention can comprise, inter alia, a central processing unit (CPU) 302, a memory 303 and an input/output (I/O) interface 304. The computer system 301 is generally coupled through the I/O interface 304 to a display 305 and various input devices 306 such as a mouse and a keyboard. The support circuits can include circuits such as cache, power supplies, clock circuits, and a communication bus. The memory 303 can include random access memory (RAM), read only memory (ROM), disk drive, tape drive, etc., or a combinations thereof. The present invention can be implemented as a routine 307 that is stored in memory 303 and executed by the CPU 302 to process the signal from the signal source 308. As such, the computer system 301 is a general purpose computer system that becomes a specific purpose computer system when executing the routine 307 of the present invention.

The computer system 301 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for monitoring mechanical and electrical functions of a medical imaging system comprising:
monitoring at least one configuration of the medical imaging system;
storing the at least one configuration in a database;
performing a diagnostic on the mechanical and electrical functions of the medical imaging system;
storing a result of the diagnostic on the mechanical and electrical functions in the database; and
correlating the at least one configuration with the result of the diagnostic.

2. The method as recited in claim 1, further comprising:
retrieving a result of the correlation from the database.

3. The method as recited in claim 2, wherein the step of retrieving further comprises:
retrieving the result of the correlation from the database remotely.

4. The method as recited in claim 2, wherein the step of retrieving further comprises:
retrieving the result of the correlation from the database onsite

5. The method as recited in claim 1, further comprising:
dispatching service personnel based on the step of correlating.

6. The method as recited in claim 1, further comprising:
updating a product life expectancy based on the step of correlating.

7. The method as recited in claim 5, wherein the step of dispatching is performed at a first price tier

8. The method as recited in claim 6, wherein the step of updating is performed at a second price tier.

9. The method as recited in claim 1, wherein the mechanical functions comprise functions for positioning the medical imaging system.

10. The method as recited in claim 1, wherein the electrical functions comprises at least one of electrical functions to position the medical imaging system and functions to perform normal operations of the medical imaging system.

11. The method as recited in claim 1, wherein the diagnostic is performed periodically.

12. The method as recited in claim 11, wherein the diagnostic is performed at least in one of hourly, daily, weekly and monthly intervals.

13. The method as recited in claim 7, wherein the step of updating further comprises:
adjusting a service interval.

14. The method as recited in claim 1, further comprising:
proactively making repairs on the medical imaging system.

15. The method as recited in claim 1, wherein the medical imaging system comprises at least one of a CT, SPECT and PET.

16. A computer readable medium having instructions for monitoring mechanical and electrical functions of a medical imaging system comprising:
a first set of instructions for monitoring at least one configuration of the medical imaging system;
a second set of instructions for storing the at least one configuration in a database;
a third set of instructions for performing a diagnostic on the mechanical and electrical functions of the medical imaging system;
a fourth set of instructions for storing a result of the diagnostic on the mechanical and electrical functions in the database; and
a fifth set of instructions for correlating the at least one configuration with the result of the diagnostic.

17. The computer readable medium as recited in claim 16, further comprising:
a sixth set of instructions retrieving a result of the correlation from the database.

18. The computer readable medium as recited in claim 16, further comprising:
a seventh set of instructions for retrieving the result of the correlation from the database remotely.

19. The computer readable medium as recited in claim 16, further comprising:
an eight set of instructions for retrieving the result of the correlation from the database onsite

20. The computer readable medium as recited in claim 16, further comprising:
a ninth set of instructions for dispatching service personnel.
